(19) United States
(12) Patent Application Publication
(10) Pub. No.: US 2014/0309759 A1
(43) Pub. Date: Oct. 16, 2014

(54) Reality/Live Books

(71) Applicant: Sherril Elizabeth Edwards, Pembroke Pines, FL (US)

(72) Inventor: Sherril Elizabeth Edwards, Pembroke Pines, FL (US)

(21) Appl. No.: 14/220,818

(22) Filed: Apr. 10, 2014

Related U.S. Application Data
(60) Provisional application No. 61/812,107, filed on Apr. 15, 2013.

(51) Int. Cl. H04L 29/06

(52) U.S. Cl. CPC H04L 65/4069
USPC 700/94

(57) ABSTRACT

Readers are required to log onto the site www.thegreaterbooks.com and then go to the ‘Live Books’ page. There they can view several different books and genre that is available. The books that have the ‘LIVE’ stamp beside them are the ones that are offered with live events and breaking news included within the story lines.

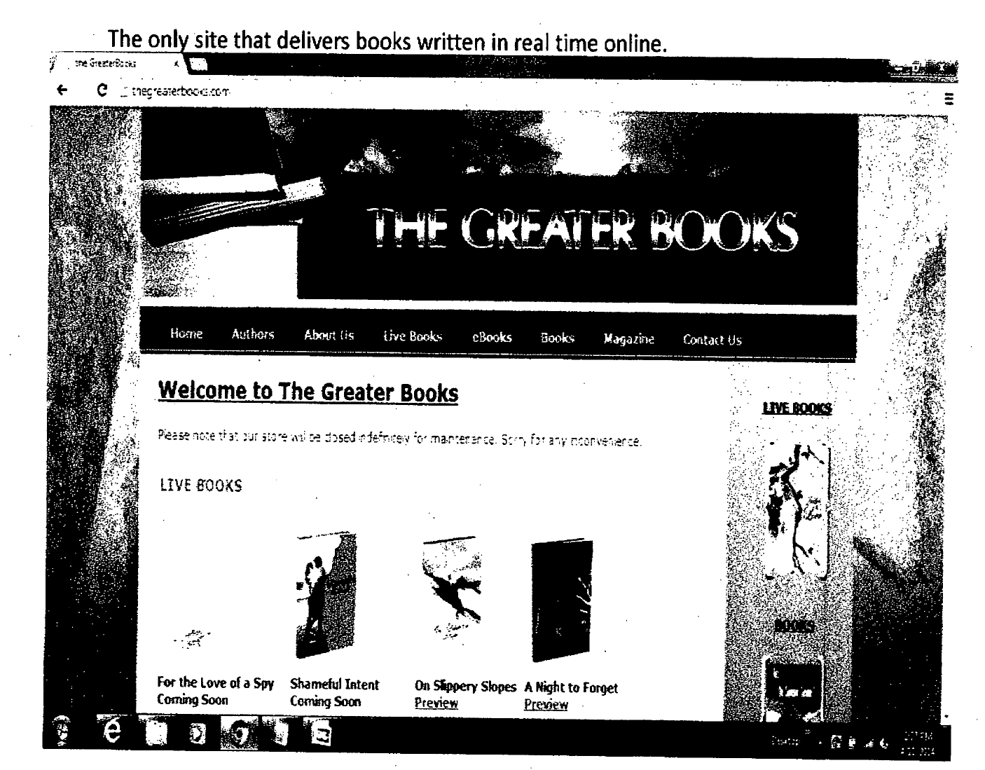

This type of delivery will help keep readers up-to-date with events and breaking news around the world while they are being entertained through reading. For those who don't have internet access, an app delivery via mobile device would achieve the same goal.

The books can be delivered in the following ways:

The first few chapters/installments are given free on a daily, weekly or monthly basis and conveyed live with current/breaking news events included within the deliverance. The rest of the book will be offered for sale upon completion. OR

All the chapters/installments will be delivered live on a daily, weekly or monthly basis and conveyed live with current/breaking news events included within the deliverance. Only the first few will be free. The readers are then required to purchase a subscription after the ‘preview’ period, to read the subsequent delivery of the daily, weekly, or monthly chapters/installments.

### INTRODUCTION

Reality/L-I-V-E Books are books that are written in real-time. A chapter is offered one or more times per week with current news events and a song to match the mood. Readers are entertained while kept up to date on current events at the same time. Hence our motto, “Read Your Books and L-I-V-E them Too!’!.

### PURPOSE OF THE INVENTION

To offer books live with current or breaking news events from all over the world woven in their story line as they read books. To keep readers up-to-date on the current news while being entertained through books

1. Books with the chapters/Installments written in real time and delivered live electronically via eBooks or apps.

2. Incorporation of current or breaking news events around the world that are woven inside the storylines and delivered live with the use of audios, graphics, and motion pictures of the events.
The use of audios, graphics or motion pictures could be used individually or simultaneously.
